(19) United States
(12) Patent Application Publication
(10) Pub. No.: US 2007/0243886 A1
(43) Pub. Date: Oct. 18, 2007

(54) Communication apparatus

(75) Inventor: Takayoshi Taniguchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/786,376

(22) Filed: Apr. 11, 2007

(30) Foreign Application Priority Data
Apr. 14, 2006 (JP) 2006-112303

(51) Int. Cl. H04Q 7/20

(52) U.S. Cl. 455/456.4

(57) ABSTRACT

A communication apparatus communicates with a radio communication device. The communication apparatus includes a display unit, a controller, a first receiver, a second receiver, and a transmission unit. The controller is configured to switch between a first mode and a second mode, the second mode in which the display unit is not supplied power. The first receiver unit is configured to receive a request message from the radio communication device in the second mode. The second receiver unit is configured to receive a measuring information that is related to a position of the communication apparatus in response to the request message received by the first receiver unit. And the transmission unit is configured to transmit position that is calculated based on the measuring information.

### CROSS-REFERENCE TO RELATED APPLICATIONS

This application is based upon and claims the benefit of priory from the prior Japanese Paten Application No. 2006-112303 filed April 14 the entire contents of which are incorporated herein by reference.

### FIELD OF THE INVENTION

The present invention relates to a communication apparatus, for example a cellular phone, or PDA.

### BACKGROUND OF THE INVENTION

In recent years, the progress and spread of cellular phones has been remarkable. The age group of cellular phone users has also been varied, and the cellular phone has become used by users of a wide age range. In order to measure position information on the cellular phone which especially a child or an old person possesses, and thus to measure the position of the child or the old person, it has been required to use other electronic equipment, and there has been technology for enabling the position of the cellular phone which a child or an old person possesses to be known.

In order to obtain the position information on the cellular phone which a child or an old person possesses, after another cellular phone (for example, mother's phone) requires the child's or old person's cellular phone to provide the position information, the child's phone or old person's phone measures a position of the phone, and the phone transmits the position to the mother's phone. Thereby, the mother was able to know the position of the child or old person.

However, when the power supply of the cellular phone which a child or an old person possesses is OFF, the mother cannot know the child's or old person's position.

### SUMMARY OF THE INVENTION

Accordingly one object of the present invention is to provide a communication apparatus which increases the possibility that a position of the communication apparatus can be obtained.

To achieve the above object, according to one aspect of the present invention communication apparatus for communicating with a radio communication device is provided which includes: a display unit; a controller configured to switch between a first mode, and a second mode in which the display unit is not supplied power; a first receiver unit configured to receive a request message from the radio communication device in the second mode; a second receiver unit configured to receive measuring information that is related to a position of the communication apparatus in response to the request message received by the first receiver unit; and a transmission unit configured to transmit a position information that is calculated based on the measuring information.

### BRIEF DESCRIPTION OF THE DRAWINGS

In the accompanying drawings:

FIG. 1 shows the outline of one form of the position information obtaining system which positions the position of the cellular phone MS1 in the first embodiment, the second embodiment, or third embodiment;

FIGS. 2A and 2B show an external appearance of the cellular phone MS1 according to an embodiment of the present invention when the cellular phone MS1 is opened to about 180 degrees;

FIGS. 3A and 3B show an external appearance of the cellular phone MS1 when the cellular phone MS1 is closed;

FIGS. 4A and 4B show an example of a display on the display 5 and an example of an arrangement of keys 6 of the cellular phone MS1;

FIG. 5 is a block diagram illustrating in a simple manner the configuration of the cellular phone MS1;

FIG. 6 is a table which shows the electronic power supply states of each component of the cellular phone MS1 in various power supply modes in the first embodiment;

FIG. 7 is a flow chart which shows a process for switching between the power supply full off-mode, power supply on-mode, and power supply off-mode of the cellular phone MS1;

FIG. 8 is a flow chart which shows operation of the position information obtaining system using the cellular phone MS1 in the first embodiment or the second embodiment;

FIG. 9 shows an example of an e-mail creation screen in the first embodiment, the second embodiment, or the third embodiment;

FIG. 10 shows another example of an e-mail creation screen in the first embodiment, the second embodiment, or the third embodiment;

FIG. 11 is a flow chart of operation of the cellular phone MS1 when the cellular phone is in the power supply on-mode 201, or the power supply off-mode 202 in the first embodiment;

FIG. 12 is a table which shows the electronic power supply states of each component of the cellular phone MS1 in various power supply modes in the second embodiment;

FIG. 13 is a flow chart of operation of the cellular phone MS1 when the cellular phone is in the power supply on-mode 201, or the second power supply off-mode 204 in the second embodiment;

FIG. 14 is a table which shows the electronic power supply states of each component of the cellular phone MS1 in various power supply modes in the third embodiment; and

FIG. 15 is a flow chart of operation of the position information obtaining system using the cellular phone MS1 in the third embodiment.

### DETAILED DESCRIPTION OF THE INVENTION

### First Embodiment

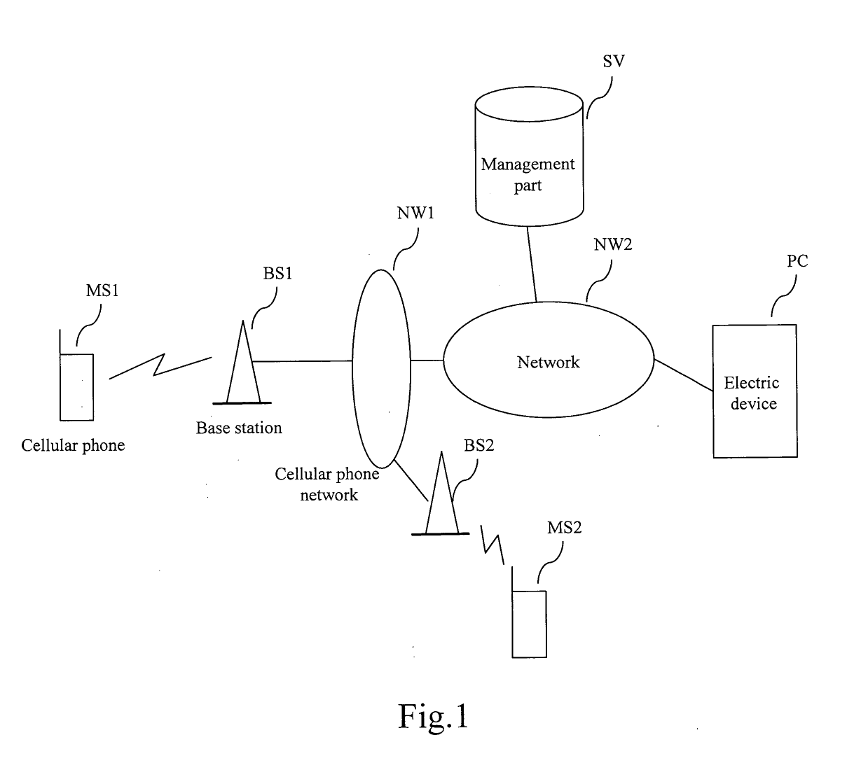

A first embodiment in which the present invention is employed in a cellular phone will be explained hereinbelow with reference to the accompanying drawings. FIG. 1 shows a system in which a first cellular phone or another electronic device requests a second cellular phone to measure its own position and transmit the measured position to the requesting device via a management part.

In the system shown in FIG. 1, the position information of a cellular phone MS1 can be requested by a cellular phone MS2 or an electronic device PC. The cellular phone MS2 may have substantially the same structure as the cellular phone MS1. In order to obtain the posirion information on the cellular phone MS1 according to one aspect of the present invention, the cellular phone MS2 generates a request for the position information (referred to below as “location request mail”), and the cellular phone MS2 transmits the location request mail to a management part SV connected to the network NW2, via a base station BS2, a cellular phone network NW1, and the network NW2. If the cellular phone MS2 transmits the location request mail to the management part SV of the position information obtaining system, the management part SV requests the position information from the cellular phone MS1 via the network NW2, the cellular phone network NW1, and the base station BS1. The cellular phone MS1 transmits the position to the management part SV of the system via the base station BS1, the cellular-phone network NW1, and the network NW2, and the position information is sent to the cellular phone machine MS2 from the management part SV via the network NW2, the cellular-phone network NW1, and the base station BS2.

The electronic device PC obtains the position information of the cellular phone MS1 in a substantially similar manner. In order to obtain the position information of the cellular phone MS1, the electronic device PC generates location request mail and transmits the location request mail to the management part SV of the system via the network NW2. If the electronic device PC transmits the location request mail to the management part SV of the system, the management part SV requests the position information from the cellular phone MS1 via the network NW2, the cellular phone network NW1, and the base station BS1. The cellular phone MS1 transmits the position information to the management part SV of the system via the base station BS1, the cellular phone network NW1, and the network NW2, and the position information is sent to the electronic device PC via the network NW2 from the management part SV.

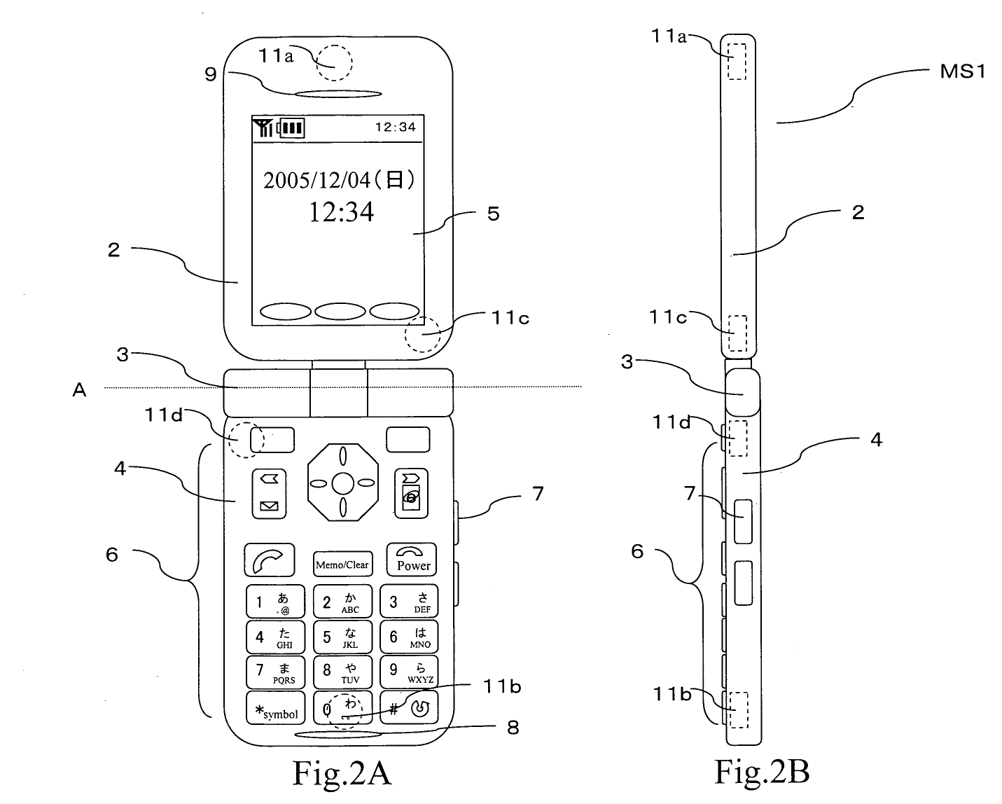

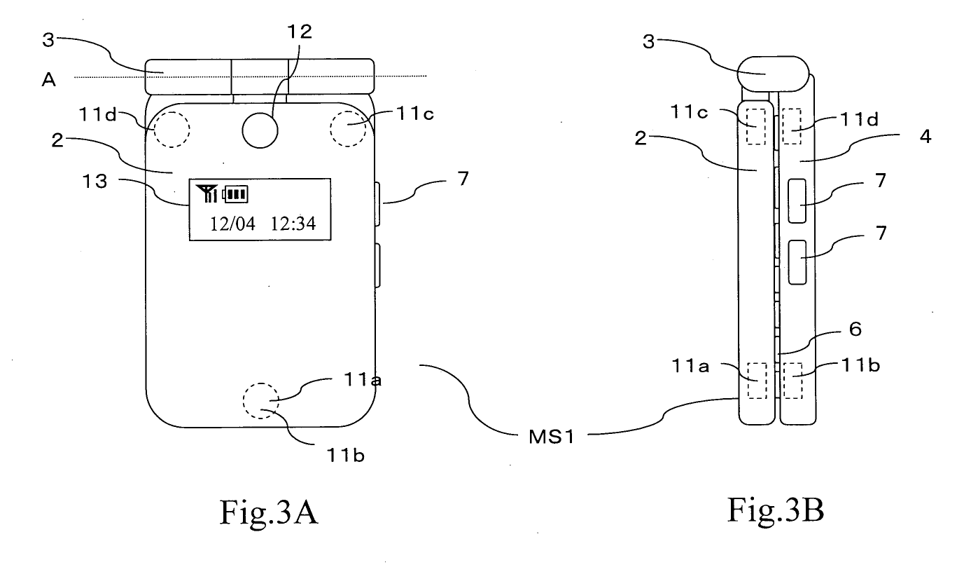

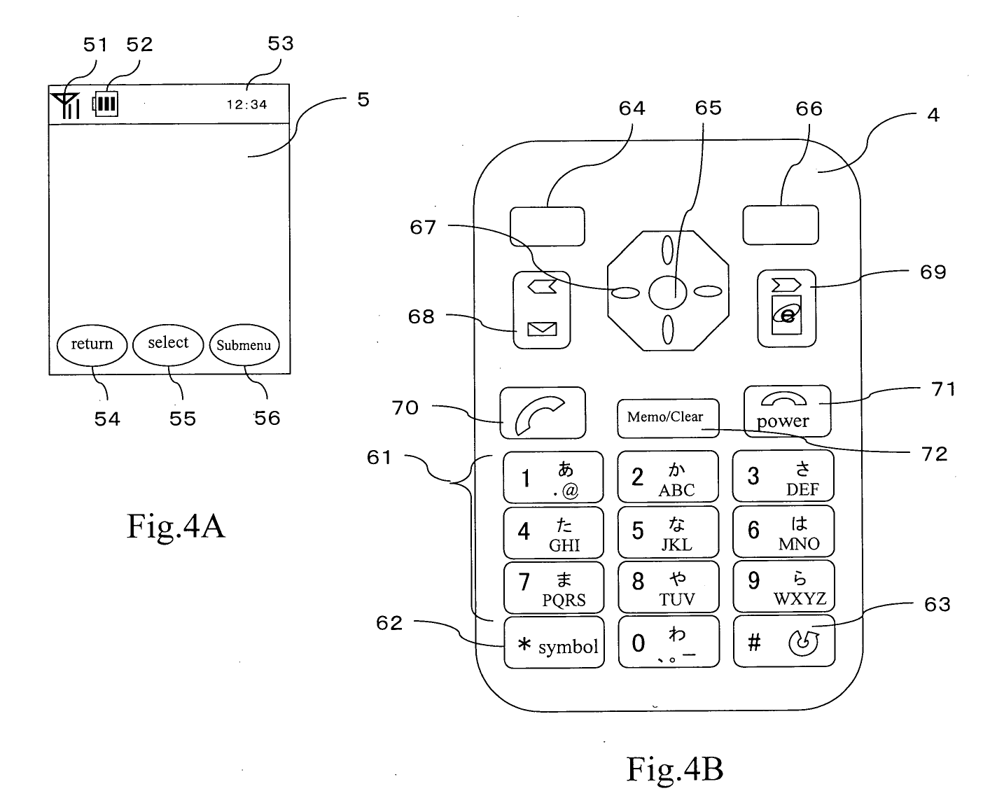

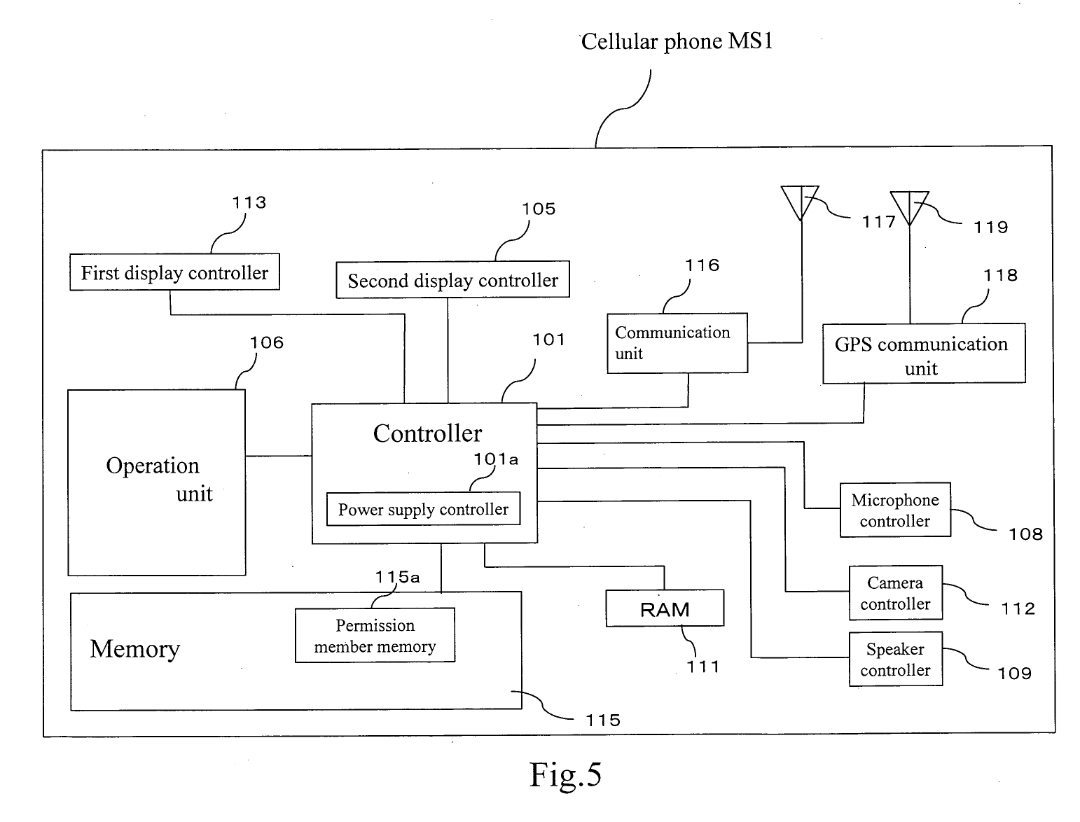

The structure of the cellular phone MS1 will be explained with respect to FIGS. 2 to 5. FIG. 2 shows an external appearance of the cellular phone MS1 when the cellular phone MS1 opened to about 180 degrees. FIG. 2A is a front view of the cellular phone MS1 and FIG. 2B is a side view thereof. FIG. 3 shows the cellular phone MS1 in a closed state. FIG. 3A is a front view of the cellular phone MS1 and FIG. 3B is a side view thereof. FIG. 4 shows an example of a display on the display 5 of the cellular phone MS1 (see FIG. 4A) and an example of an arrangement of the keys 6 of the cellular phone MS1 (see FIG. 4B). And FIG. 5 is a block diagram illustrating an internal configuration of the cellular phone MS1.

The cellular phone MS1 has an upper case section 2 and a lower case section 4 which is connected to the upper section 2 via a hinge 3. The upper case section 2 has a display 5 such as an LCD, a speaker 9 for outputting sound (such as a voice), magnetic sensors 11a, 11c for detecting an orientation of the upper case section 2 with respect to the lower case section 4, a camera 12, and a sub-display 13 such as an LCD. The sub-display 13 and camera 12 are provided on the same surface of the upper case section 2.

The lower case section 4 has digit/letter keys 6 for inputting, e.g., digits, letters or instructions, side keys 7 for conducting operations of the cellular phone MS1, a microphone (mouthpiece) 8 for sound collection, and magnetic sensors 11b, 11d for detecting an orientation of upper case section 2 with respect to the lower case section 4.

As shown in FIG. 5, which illustrates the internal configuration of the cellular phone MS1, the cellular phone MS1 includes a controller 101 for conducting control of the entire cellular phone MS1, a microphone controller 108, a speaker controller 109, a camera controller 112 for controlling the camera 12, a memory 115 including a ROM or a NAND memory, a volatile RAM 111 for temporary storage, a first display controller 113 for controlling the display 5, a second display controller 105 for controlling the sub-display 13, an operation unit 106 for recognizing that the keys 6, and side keys 7 have been pushed down, a communication unit 116 for conducting wireless communication control by using an antenna 117, and a GPS communication unit 118 for conducting wireless communication control by using a GPS antenna 119. The entire system is controlled by the controller 101. The controller 101 also controls whether the position of the cellular phone MS1 is permitted to be obtained by external devices. The controller 101 includes power supply controller 101a, which perform power supply control in accordance a power supply mode set by a user (described in greater detail below).

The memory 115 stores a programs executed by the controller 101 and various information data, and the memory 115 includes a permission member (authorized requester) memory 115a, which stores information, such as, for example, an e-mail address and/or a terminal ID. The information stored in the permission member memory 115a identifies one or more e-mail addresses and/or one or more terminals, for example, which are permitted to obtain the position information of the cellular phone MS1.

The display controller 105 controls the sub-display 13 and display controls the display data that are instructed by the controller 101 to be outputted.

The display controller 113 controls the display 5 and display controls the display data that are instructed by the controller 101 to be outputted.

The communication unit 116 has functions of sending information indicated by the controller 101 by wireless communication via the antenna 117 and receiving information sent by wireless communication via the antenna 117.

The GPS communication unit 118 is activated by the controller 101. The GPS communication unit 118 has a function of transmitting and receiving information through the GPS antenna 119 to determine the location of the cellular phone MS1, if a request for obtaining the information to determine the location of the cellular phone MS1 is received from the controller 101.

The camera controller 112 is activated by the controller 101, and images inputted from the camera 12 are displayed, e.g., on display 5 via the first display controller 113 or on display sub-display 13 via the second display controller 105.

The operation unit 106 has a key input unit for recognizing that the keys 6 and side keys 7 have been pushed. The operation unit 106 can recognize that a plurality of kinds of keys including digit keys, letter keys, and functional keys. When a keys 6 or side key 7 is operated by a user, the operation unit 106 conveys a recognition signal corresponding to the operated key to the controller 101, which starts an operation corresponding to the operated key.

As shown in FIG. 4B, the lower case section 4 has the following keys 6: digit keys 61, a “*” key 62, a “#” key 63, a soft key left 64, a confirmation key 65, a soft key right 66, a cross-like key 67, a mail key 68, a browser key 69, a telephone key 70, a power source key 71, and a clear key 72. In addition to digits, Japanese alphabet KANA symbols, various signs, and English alphabet letters are allocated to the digit keys 61. For example, the numeral “1”, Japanese KANA symbols “ [symbol] ”, “ [symbol] ”, “ [symbol] ”, “ [symbol] ”, “ [symbol] ” (respectively represented by “a”, “i”, “u”, “e”, and “o” in English alphabet letters), and signs “,”, “@” are allocated to the key “1”. In addition, numeral “2”, Japanese KANA symbols “ [symbol] ”, “ [symbol] ”, “ [symbol] ”, “ [symbol] ”, “ [symbol] ” (respectively represented by “ka”, “ki”, “ku”, “ke” and “ko” in English alphabet letters), and alphabet letters “A”, “B”, “C”, “a”, “b”, “c” are allocated to key “2”. Still further, in addition to the asterisk allocated to “*” key 62, in a letter input state, a symbol list and pictogram list can by called up by the key 62. Furthermore, in addition to the pound sign allocated to the “#” key 63, in a letter input state key 63 can be operated to toggle the letter that can be input with the digit keys 61.

The cross-like key 67 includes an upper key, a lower key, a left key, a right key, and the confirmation key 65 is provided in the center of the direction keys. The cross-like key 67 can be operated to move the cursor in the up-down and left-right directions. In addition, the confirmation key 65 can be pushed to confirm various functions. The mail key 68 can call up a mail send/receive function. The browser key 69 allows for connection to Web or the like. The telephone key 70 is mainly used when receiving a phone call or when an usual operations of making a phone call. The power source key 71 is mainly used to turn the power source ON and OFF, as well as to complete a function or editing and to erase a letter while a letter(s) is/are being input. Furthermore, if the clear key 72 is pushed in a standby screen, a memo register can be called up.

As shown in FIG. 4A, an antenna pictogram 51 showing the present level of sensitivity of the antenna 117, a battery pictogram 52 showing the present remaining battery charge of the cellular phone MS1, and a time display 53 displaying the current time are displayed in the uppermost row (referred to hereinbelow as “upper pictogram row”) of the display 5 of the cellular phone MS1. In addition, simple explanations of the functions presently executable by operating the left soft key 64, the confirmation key 65 and the right soft key 66 are displayed in the lowermost row (referred to hereinbelow as “lower pictogram row”) of the display 5 of the cellular phone MS1. More specifically, an explanation corresponding to the left soft key provided by the lower left pictogram 54, an explanation corresponding to the confirmation key 65 is provided by the central lower pictogram 55, and an explanation corresponding to the right soft key 66 is provided by the lower right pictogram 56. For example, in the display shown in FIG. 4A, if the left soft key 64 is pushed, a “RETURN” function is executed; if the confirmation key 65 is pushed, the function that is presently highlighted/identified (not shown in the figure) can be selected; and if the right soft key 66 is pushed, a “sub-menu” is displayed.

As described hereinabove, moreover, sensors 11a to 11d for detecting the orientation of the upper case section 2 with respect to the lower case section 4 are provided in the upper case section 2 and lower case section 4. The sensors 11a to 11d comprise, for example, magnetic sensors. For example, when a distance of the sensor 11a and the sensor 11b are approached within a fixed range, the sensor 11a outputs a detection signal. The orientation of the upper case section 2 with respect to the lower case section 4 is detected by the detection signal. Of the sensors 11a to 11d, a pair of sensors 11a and 11b detect whether or not the upper case section 2 and lower case section 4 lie one on top of another (are closed/overlapped). And when the upper case section 2 and lower case section 4 lie on top of one another, a pair of sensors 11c and 11d detect whether the display 5 is inward (for example the state shown in FIG. 3) or the sub-display 13 is inward (the display 5 is outward).

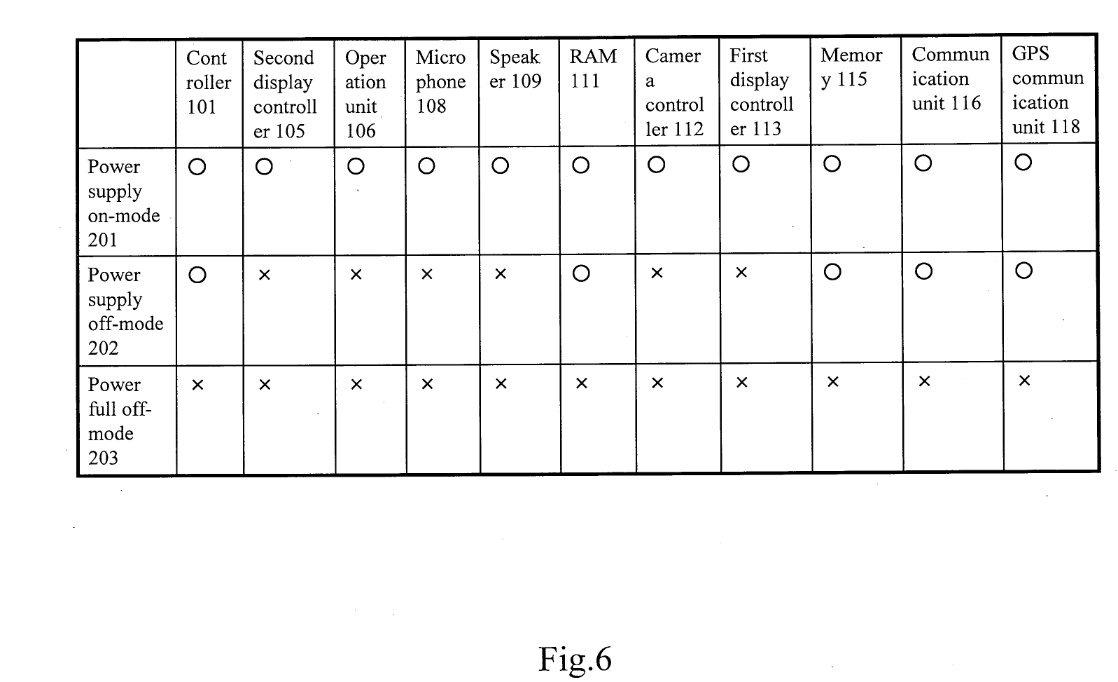

Next, the position information obtaining system using the cellular phone MS1 respect to FIGS. 6 to 11. The cellular phone MS1 can be placed in a power supply on-mode 201, a power supply off-mode 202, and a power supply full off-mode 203. FIG. 6 indicates the elements of the cellular phone MS1 that are supplied with power in each of the three power supply modes (in FIG. 6, a circle designates that power supply is ON, and an “x” designates that power supply is OFF). First, in the power supply on-mode 201, the controller 101, the second display controller 105, the operation unit 106, the microphone controller 108, the speaker controller 109, RAM 111, the camera controller 112, the first display controller 113, the memory 115, the communication unit 116, and the GPS communication unit 118 are all in a state in which the power supply thereto is turned on, or in a suspend state in which a power supply ON is possible.

Second, in the power supply off-mode 202, at least the controller 101, RAM 111, the memory 115, the communication unit 116, and the GPS communication unit 118 are in the state in which the power supply thereto is turned on, or in the suspend state in which a power supply ON is possible. In addition, in the power supply off-mode 202, the other elements of the cellular phone MS1 are in a state in which the power supply thereto is turned off, except for the typical exception (for example, power source key 71).

Third, in the power full off-mode 203, the controller 101, the second display controller 105, the operation unit 106, the microphone controller 108, the speaker controller 109, RAM 111, the camera controller 112, the first display controller 113 the memory 115 the communication unit 116 and the GPS communication unit 118, are all in the state in which the power supply is turned off. In addition, in the power full off-mode 203, a RTC (real-time clock, which is not illustrated) and some other elements may be turned on.

Since more elements are supplied with power in the power supply off-mode 202 than in the power full off-mode 203, power consumption is less in the power full off-mode 203 than in the power supply off-mode 202.

In addition, in the power supply off-mode 202 and the power full off-mode 203, since the second display controller 105 and first display controller 113 are not supplied with power, the power supply of the display 5 and sub-display 13 also turned off. Moreover, in the power supply off-mode 202, if a location request mail is received by the cellular phone MS1 (as will hereinafter be described in detail), the communication unit 116 transmits an ACK signal, which advises the management part SV that the cellular phone MS1 has received the location request mail. In the power supply off-mode 202, the controller 101 controls the communication unit 116 such that the communication unit 116 does not transmit a reply signal (for example the ACK signal) if the communication unit 116 receives another signal (for example a signal indicating an ordinary mail or a signal indicating an incoming call).

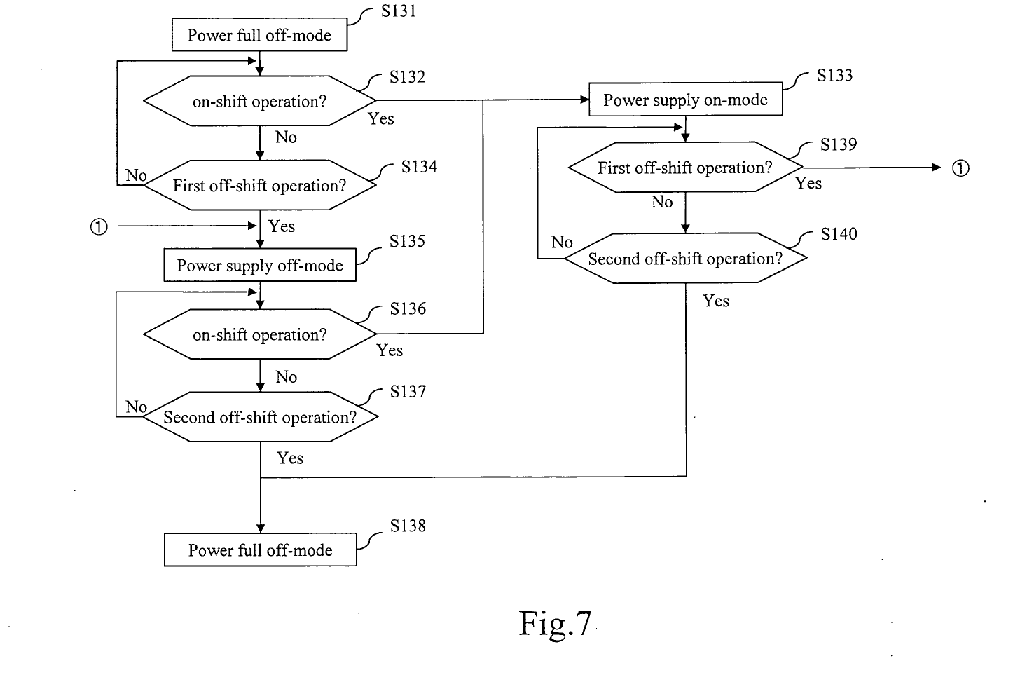

Next, transition between the power full off-mode 203, the power supply off-mode 202, and the power supply on-mode 201 will be explained with respect to FIG. 7, in which the cellular phone MS1 is initially set in the power full off-mode 203 (Step S131). Next, the controller 101 detects whether an on-shift operation (for example, a power supply “ON” operation such as depression more than a predetermined (fixed time) to shift the cellular phone MS1 to the power supply on-mode 201 has been made via the operation unit 106 (Step S132). If the controller 101 detects that the on-shift operation has been made (Yes of Step S132), the controller 101 performs control to shift the cellular phone MS1 to the power supply on-mode 201 (Step S133). On the other hand, if the controller 101 detects that the on-shift operation has not been made via the operation unit 106, the controller 101 proceeds to Step S134 (No of Step S132).

In Step S134, the controller 101 detects whether a first off-shift operation (for example, depression of the power source key 71 twice within a fixed time) to shift the cellular phone MS1 to the power supply off-mode 202 has been made via the operation unit 106 (Step S134). If the controller 101 detects that the first off-shift operation has been made (Yes of Step S134), the controller 101 performs control to shift the cellular phone MS1 to the power supply off-mode 202 (Step S135). If the controller 101 detects that the first off-shift operation has not been made via the operation unit 106, the controller 101 returns to Step S132 (No of Step S134) and the controller 101 again detects whether the on-shift operation has been made.

Next, in the power supply off-mode 202 of Step S 135, the controller 101 detects whether the on-shift operation to shift the cellular phone MS1 to the power supply on-mode 201 (for example, depression of the power source key 71 for more than a fixed time) has been made via the operation unit 106 (Step S136). If the controller 101 detects that the on-shift operation has been made (Yes of Step S136), the controller 101 performs control to shift the cellular phone MS1 to the power supply on-mode 201 (Step S133). If the controller 101 instead detects that the on-shift operation has not been made via the operation unit 106, the controller 101 proceed to Step S137 (No of Step S136).

Next, in the Step S137, the controller 101 detects whether a second off-shift operation (for example, depression of the power source key 71 for more than a fixed time following the entering of a four-digit personal identification number via digit keys 61) to shift the cellular phone MS1 to the power full off-mode 203 has been made by the operation unit 106 (Step S1 37). If the controller 101 detects that the second off-shift operation has been made (Yes of Step S137), the controller 101 performs control to shift the cellular phone MS1 to the power full off-mode 203 (Step S138). If the controller 101 detects that the second off-shift operation to has not been made via the operation unit 106, the controller 101 returns to Step S136 (No of Step S137) and the controller 101 again detects whether the on-shift operation has been made.

Next, in the power supply on-mode 201 of Step S133, the controller 101 detects whether the first off-shift operation to shift the cellular phone MS1 to the power supply off-mode 202 (for example, depression of the power source key 71 twice within a fixed time) has been made via the operation unit 106 (Step S139). If the controller 101 detects that the first off-shift operation has been made (Yes of Step S139), the controller 101 performs control to shift the cellular phone MS1 to the power supply off-mode 202 (Step S 135). If the controller 101 detects that the first off-shift operation has not been made via the operation unit 106, the controller 101 proceeds to Step S140 (No of Step S139).

In Step S140, the controller 101 detects whether the second off-shift operation (for example, depression of the power source key 71 for more than a fixed time following the entering of the four-digit personal identification number via the digit keys 61) to shift the cellular phone MS1 to the power full off-mode 203 has been made via the operation unit 106 (Step S140). If the controller 101 detects that the second off-shift operation has been made (Yes of Step S140), the controller 101 performs control to shift to the cellular phone MS1 to the power full off-mode 203 (Step S138). If the controller 101 detects that the second off-shift operation has not been made via the operation unit 106, the controller 101 returns to Step S139 (No of Step S140) and the controller 101 again detects whether the on-shift operation has been made.

The on-shift operation, the first off-shift operation, and the second off-shift operation are not limited to the examples described above. It may be desirable for the second off-shift operation to be an operation that is not simple so that it cannot be performed by mistake. Of course, in the power supply on-mode 201, naturally the usual operations of making a phone call, creating mail, etc. can be performed by the user, but a description of these functions is omitted.

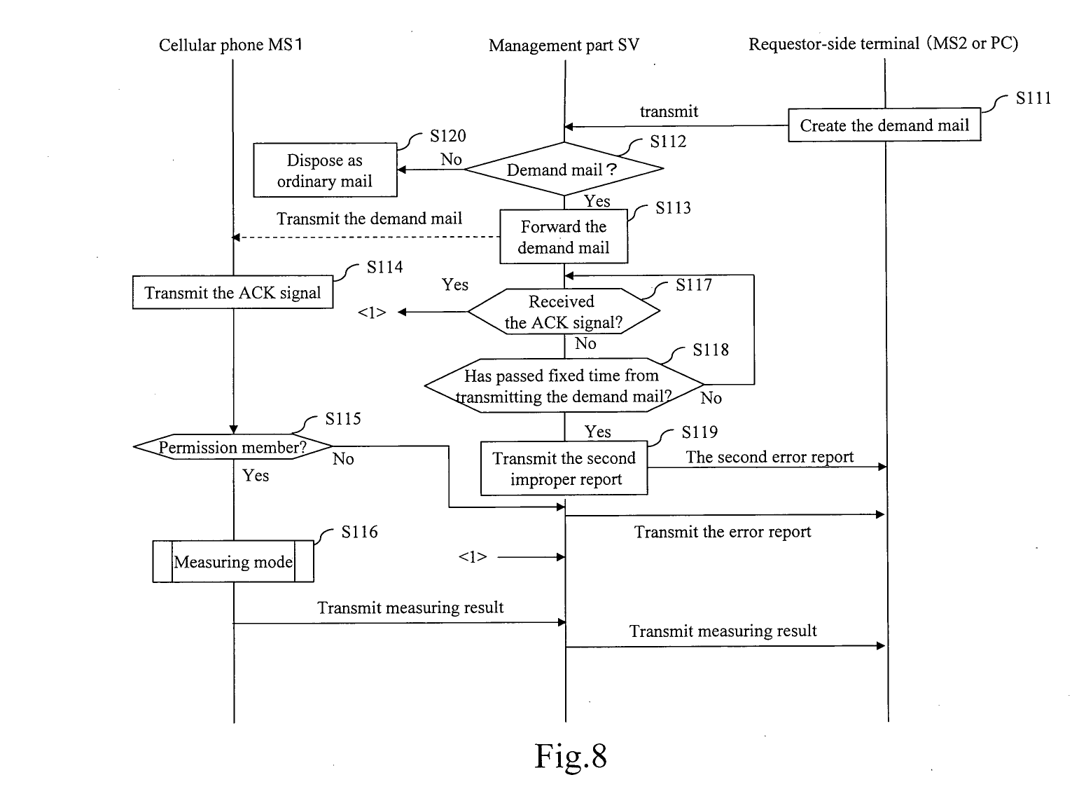

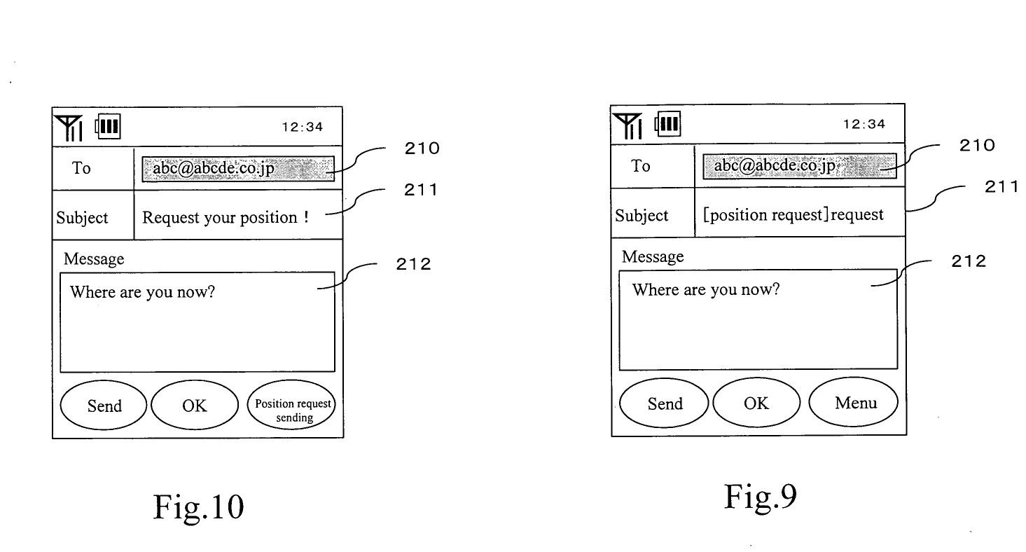

Next, with reference to FIG. 8, operation of the position information positioning system using the cellular phone MS1 will be explained. First, when the user of a requestor-side terminal device(s) (for example, the cellular phone MS2, the electronic device PC, etc) wants to know the location of the cellular phone MS1, the requestor-side terminal device creates the location request mail transmits the request mail to the management part SV (Step S111) based on input (e.g. via keys) by the user of the requestor-side terminal device. In addition, in order to make the management part SV recognize the difference between the location request mail and ordinary mail, when the requestor-side terminal device creates the location request mail, it is desirable to distinguish the location request mail by putting in keywords, such as “position demand”, etc., in the subject 211 of the location request mail, as shown in the e-mail creation screen shown in FIG. 9. Alternatively, the location request mail may be distinguished from a ordinary mail by providing different keys to initiate transmission of the location request mail and the ordinary mail, as shown in FIG. 10.

More specifically, FIG. 9 shows one example of an e-mail creation screen. In FIG. 9 shows that the destination of the e-mail is highlighted. If the cross-like key 67 is operated in a first direction by the user, the first display controller 113 performs control to move a focus toward the first direction. Moreover, if the confirmation key 65 is pressed when an item is highlighted, the first display controller 113 may perform control to display details of the highlighted item (e.g. a guide indication that is displayed at the central lower pictogram 55).

FIG. 10 shows an alternative example of an e-mail creation screen. Explanation is omitted for the portions of FIG. 10 that are the same as the corresponding portions of FIG. 9.

As shown in FIG. 10, transmission of an ordinary mail is initiated by pushing the left soft key 64. On the other hand, transmission of the location request mail is initiated by pushing the right soft key 66. In addition, while an e-mail is being created, as shown in FIG. 10 the first display controller 113 displays a first guide “send” at the lower left pictogram 54 of the display 5. The controller 101 performs control to transmit the created mail via the communication unit 116 as ordinary mail if the controller 101 detects that the left soft key 64is pushed while the screen shown in FIG. 10 is displayed. Moreover, the controller 101 performs control to set a flag to identify the mail as location request mail and performs controls to transmit the created mail via the communication unit 116 as the location request mail, if the controller 101 detects that the right soft key 66 is pushed while the screen shown in FIG. 10 is displayed. The location request mail can thereby be distinguished from ordinary mail.

In the e-mail creation screens shown in FIG. 9 and FIG. 10, identification of the location request mail is not limited to entering specific keywords in the subject of the e-mail. The controller 101 may alternatively set a character (or a pictorial symbol and a mark) of the head of the text or at the tail of the text. In addition, in the example shown in FIG. 10, the controller 101 need not necessarily set a flag to identify the mail as location request mail. The controller 101 may alternatively attach a preset attached file if the controller 101 detects that the right soft key 66 (initiating transmission of location request mail) is pushed.

Returning to FIG. 8,. in Step S111, if the requestor-side terminal device MS2 (or PC) transmits a mail, the management part SV receives the mail. The management part SV detects whether the received mail is location request mail or ordinary mail (Step S112). More specifically, the management part SV analyzes the received mail, and detects whether the received mail is the location request mail based on, for example, ON/OFF of the flag, or based on the existence of a keyword in the subject of the mail.

If the management part SV detects that the received mail is the location request mail (Yes of Step S112), the management part SV forwards the location request mail to the cellular phone MS1 (Step S113).

If the cellular phone MS1 is capable of receiving the location request mail, the cellular phone MS1 receives the location request mail. That is, the cellular phone MS1 cannot receive the location request mail if the communication unit 116 of the cellular phone MS1 is not supplied power, so that the communication unit 116 of the cellular phone MS1 cannot receive the location request mail (for example, in the power full off-mode 203). Next, if the cellular phone MS1 receives the location request mail, the cellular phone MS1 transmits an ACK signal indicating that demand mail was received, to the management part SV (Step S114). The controller 101 of the cellular phone MS1 detects whether a mail address of a transmitting agency of the location request mail corresponds with a mail address stored in the permission member memory 115a of the memory 115 (Step S115). If the controller 101 detects that the mail address of the transmitting agency does not correspond with any mail address stored in the permission member memory 115a, the controller 101 transmits an error report, which is a notice that the cellular phone does not permit to notice a position of the cellular phone MS1, to the requestor-side terminal device via the management part SV.

Moreover, in Step S11 5, if the controller 101 detects that the mail address of the transmitting agency corresponds with a mail address stored in the permission member memory 115a, the controller 101 shifts to a measuring mode (Step S116) to acquire the position of the cellular phone MS1. Then, the communication unit 116 of the cellular phone MS1 transmits the position information acquired in the measuring mode to the requestor-side terminal device via MS2 (or PC) the management part SV. The measuring mode is described in more detail later.

After the management part SV transmits the location request mail in Step S113, the management part SV detects whether it has received the ACK signal from the cellular phone MS1 (Step S117). If the management part SV has received the ACK signal, the management part SV awaits reception of the measuring result from the cellular phone MS1 (Yes of Step S117, to <1>). If the management part SV does not receive the ACK signal, the management part SV detects whether a fixed time from transmission of the location request mail in Step S113 has passed (Step S118). If fixed time has not passed in Step S118, the management part SV returns to Step S117 and again detects whether the management part SV has received the ACK signal from the cellular phone MS1 (No of Step S118). If the fixed time has passed in Step S118, the management part SV transmits a second error report, which is a notice that the cellular phone MS1 cannot measure the positioning of the cellular phone MS1, to the requestor-side terminal device (Yes of Step S118, and Step S119).

Moreover, in Step S112, if the management part SV detects that the received mail is not the location request mail (No of Step S112), the management part SV treats the mail as ordinary mail (Step S120).

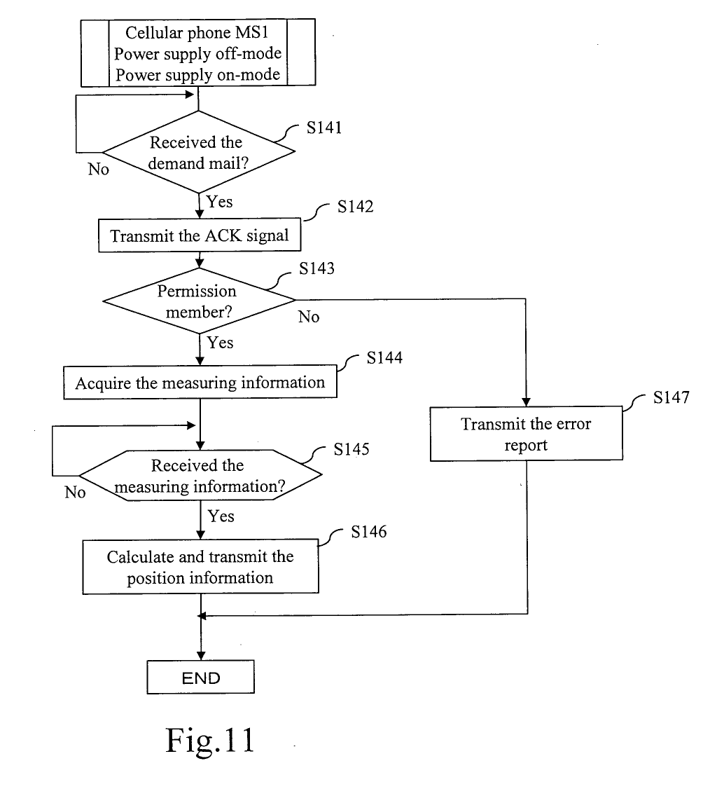

Next, the operation of the cellular phone MS1 in the position information positioning system operating as shown FIG. 8 will be described with respect to FIG. 11, which is a flow chart of operation of the cellular phone MS1 when the cellular phone MS1 is in power supply on-mode 201 or in power supply off-mode 202. As described above, in power supply full off-mode 203, the cellular phone MS1 cannot receive the location request mail.

First, the controller 101 detects whether it has received the location request mail from the management part SV (Step S141). Here, if the controller 101 does not detect that the location request mail is received, the controller 101 to perform Step S141 (No of Step S141). And if the controller detects that the location request mail has been received in Step S141, the controller S101 controls the communication unit 116 to transmit the ACK signal to the management part SV (Step S142).

Next, the controller 101 detects whether a mail address of a transmitting agency corresponds with a mail address stored in the permission member memory 115a of the memory 115 (Step S143). If the controller 101 detects that the mail address of the transmitting agency does not correspond with any mail address stored in the permission member memory 115a, the controller 101 transmits the error report (a notice that the cellular phone MS1 does not permit to notice a position of the cellular phone MS1) to the requestor-side terminal device (No of Step S143, Step S147).

Moreover, in Step S143, if the controller 101 detects that the mail address of the transmitting agency corresponds with a mail address stored in the permission member memory 115a, the controller 101 controls the GPS communication unit 118 so as to acquire the measuring information of the cellular phone MS1 (Step S144, positioning mode start). The GPS communication unit 118 acquires measuring information (for example, time information) for acquiring the position information of the cellular phone MS1 from a satellite. The controller 101 detects whether it received the measuring information from the GPS communication unit 118 (Step S145). If the controller 101 receives the measuring information, the controller 101 calculates the position information of the cellular phone MS1 based on the received the measuring information. And the controller 101 performs control to transmit the position information to the requestor-side terminal device MS2 (or PC) (Yes of Step S145, Step S146, positioning mode end). It is desirable to transmit the position information by adding the position information to a reply mail to the location request mail. Moreover, calculation of positioning information in Step S 146 may be to calculate in the server which is not illustrated, may receive the calculated positioning information, and may transmit to the requestor-side terminal MS2 after receiving the calculated positioning information.

### Second Embodiment

Below, second embodiment of the present invention, as it relates to a cellular phone, will be explained herein below with reference to the accompanying drawings. According to the second embodiment, less elements of the cellular phone are supplied with power in the power supply off-mode than according to the first embodiment. In addition, the composition of the system configuration of the cellular phone MS1, the management part SV, and the requestor-side terminal MS2 (or PC) (as shown in FIGS. 1-5 and 7-10) is the same as in the first embodiment, and an explanation thereof is omitted below.

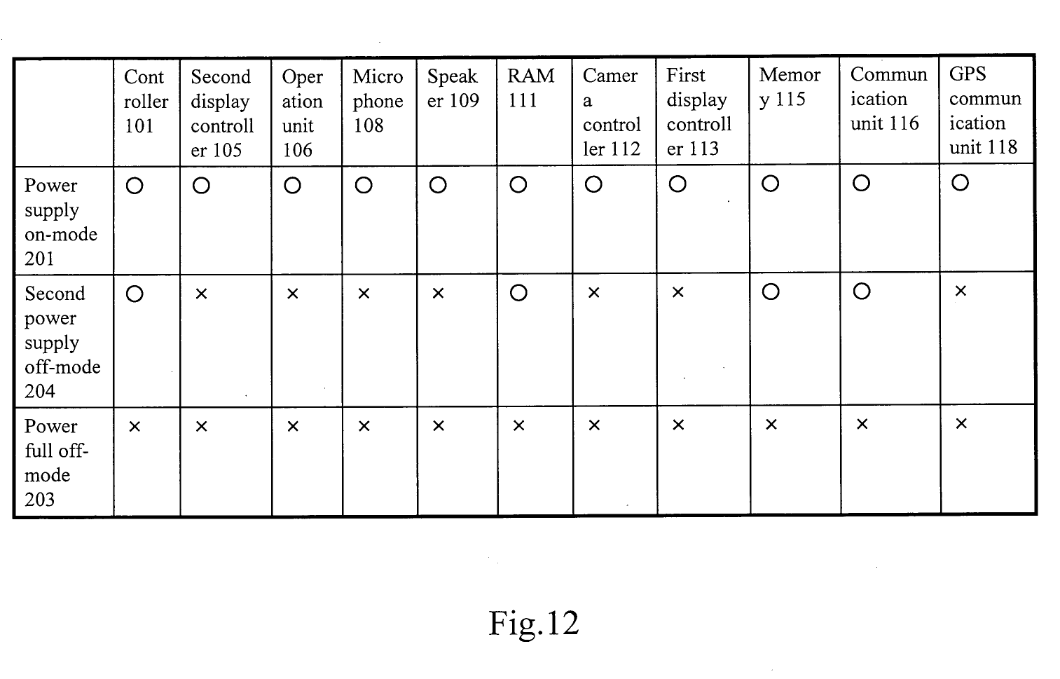

FIG. 12 shows the power supply state of each component of the cellular phone MS1 in the second embodiment. According to the second embodiment, the cellular phone MS1 may be set in the power supply on-mode 201, the power full off-mode 203, and a second power supply off-mode 204. The power supply on-mode 201 and the power supply full off-mode 203 the same in the second embodiment as in the first embodiment. Accordingly, an explanation thereof is omitted.

In the second power supply off-mode 204, at least the controller 101, RAM 111, the memory 115, and the communication unit 116 are in the state in which the power supply is turned on, or in a standby state in which a power supply ON is possible, and the other components are in the power supply off state except for the typical exceptions (for example, power source key 71). In addition, in the second power supply off-mode 204, since the second display controller 105 and the first display controller 113 are in the power supply off state, the power supply of the display 5 and the sub-display 13 is also turned off.

In addition, since more elements are not supplied with power in the second power supply off-mode 204 than in the power supply off-mode 202, power consumption is less in the second power supply off-mode 204 of the second embodiment than in the power supply off-mode 202 of the first embodiment. According to the second embodiment, shifting between the power supply on-mode 201, the power supply full off-mode 203, and the second power supply off-mode 204 is the same as the shifting between modes according to the first embodiment that is explained above with respect to FIG. 7, explanation thereof is omitted.

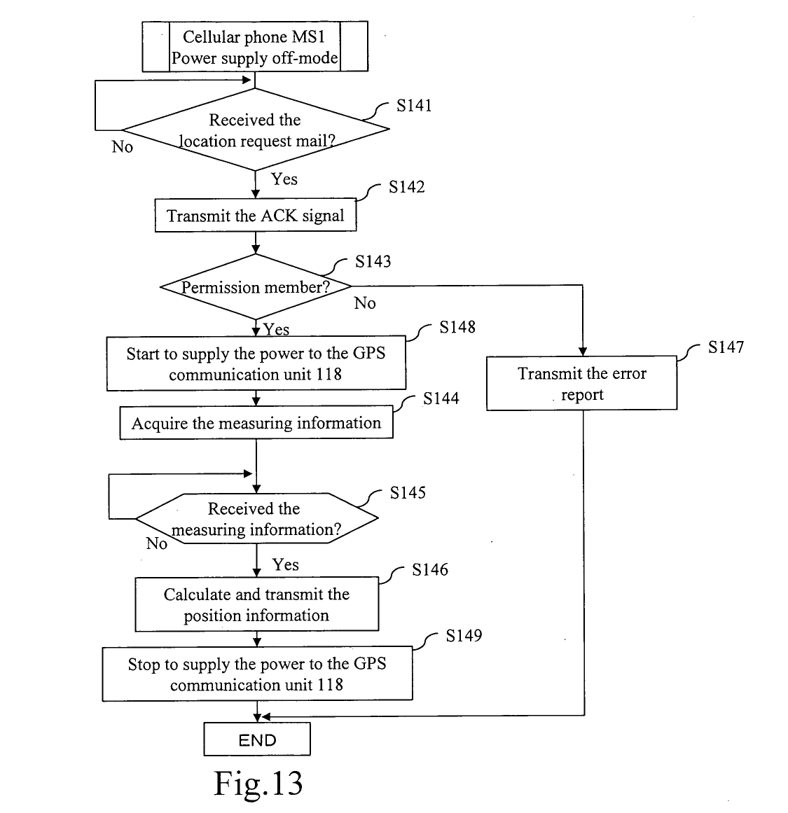

Next, in the second embodiment, a flow of operation when the cellular phone MS1 is in the second power supply off-mode 204 will be described with respect to FIG. 13. The other flows of operation of the cellular phone MS1 according to the second embodiment are the same as the flows of operation of the cellular phone MS1 according to the first embodiment. Accordingly, a explanation thereof is omitted.

First, the controller 101 detects whether it has received the location request mail from the management part SV (Step S141). Here, if the controller 101 does not detect that it has received the location request mail, the controller 101 continues Step S141 (No of Step S141). If the controller 101 does detect that it has received the location request mail, the controller 101 performs control such that the communication unit 116 transmits the ACK signal to the management part SV (Step S142).

Next, the controller 101 detects whether a mail address of a transmitting agency corresponds with a mail address stored in the permission member memory 115a of the memory 115 (Step S143). If the controller 101 detects that the mail address of the transmitting agency does not correspond with any mail address stored in the permission member memory 115a, the controller 101 transmits the error report (a notice that the cellular phone MS1 does not permit to notice a position of the cellular phone MS1) to the requestor-side terminal device (No of Step S143, Step S147).

Moreover, in Step S143, if the controller 101 detects that the mail address of the transmitting agency corresponds with a mail address stored in the permission member memory 115a, the controller 101 performs control to initiate power supply to the GPS communication unit 118 (Step S148, positioning mode start). Then, the controller 101 performs control such that the GPS communication unit 118 acquires the measuring information of the cellular phone MS1 (Step S144). The GPS communication unit 118 acquires the measuring information (for example, time information) for acquiring the position information of the cellular phone MS1 from a satellite. The controller 101 detects whether it has received the measuring information from the GPS communication unit 118 (Step S145). If the controller 101 receives the measuring information, the controller 101 calculates the position information of the cellular phone MS1 based on the received the measuring information. And the controller 101 performs control to transmit the position information to the requestor-side terminal device MS2 (or PC) (Yes of Step S145, Step S146, positioning mode end). Next, the controller 101 performs control to stop the supply of power to the GPS communication unit 118 (Step S149).

### Third Embodiment

Below, a third embodiment of the present invention, as it relates to a cellular phone, will be explained herein below with reference to the accompanying drawings. According to the second embodiment, less elements of the cellular phone are supplied with power in the power supply off-mode than according to the first and second embodiments. In addition, according to the third embodiment the flow of operation of the position information obtaining system differs from the first and second embodiments. According to the third embodiment, the composition of the system configuration of the cellular phone MS1, the management part SV, and the requestor-side terminal MS2 (or PC (as shown in FIGS. 1-5 and 7) is the same as in the first embodiment, and an explanation thereof is omitted below.

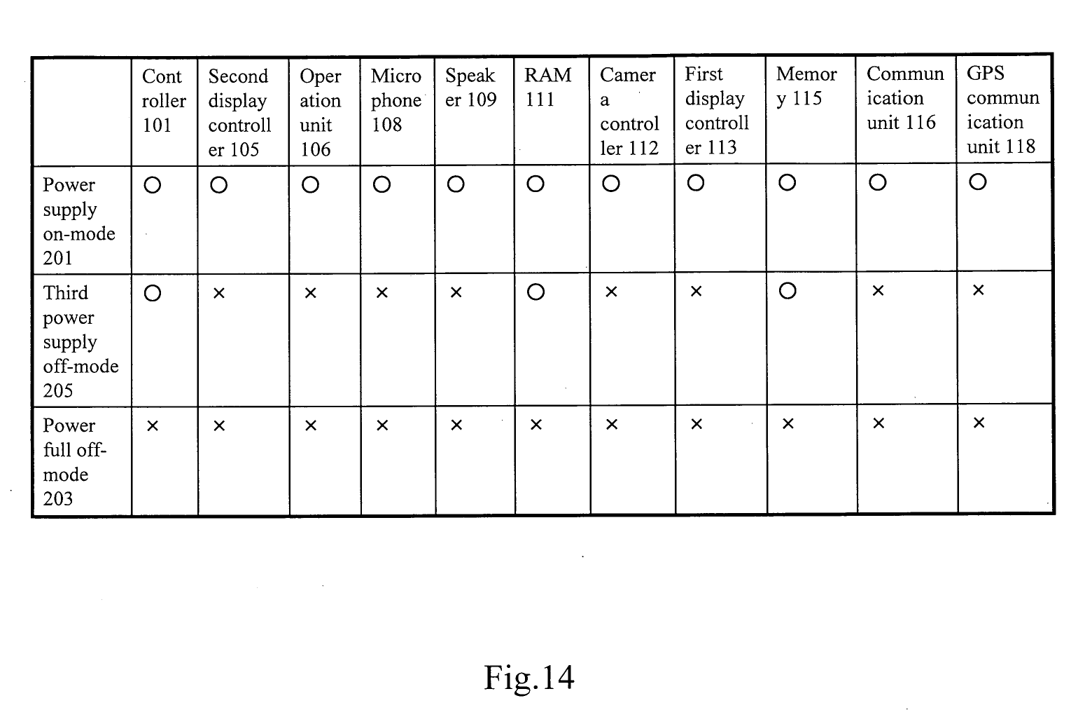

FIG. 14 shows the power supply state of each component of the cellular phone MS1 in the third embodiment. According to the third embodiment, the cellular phone MS1 may be set in the power supply on-mode 201, the power full off-mode 203, and a third power supply off-mode 205. The power supply on-mode 201 and the power supply full off-mode 203 is the same in the third embodiment as in the first embodiment. Accordingly, an explanation thereof is omitted.

In the third power supply off-mode 205, at least the controller 101, RAM 111, and the memory 115 are in the state in which the power supply is turned on, or in a standby state in which a power supply ON is possible, and the other components are in the power supply off state except for the typical exceptions (for example, power source key 71). In addition, in the third power supply off-mode 205, since the second display controller 105 and the first display controller 113 are in the power supply off state, the power supply of the display 5 and the sub-display 13 is also turned off.

In addition, since more elements are not supplied with power in the third power supply off-mode 205 than in the second power supply off-mode 204, power consumption is less in the third power supply off-mode 205 of the third embodiment than in the power supply off-mode 204 of the second embodiment. According to the third embodiment, shifting between the power supply on-mode 201, the power supply full off-mode 203, and the third power supply off-mode 205, is the same as the shifting between modes according to the first embodiment that is explained above with respect to FIG. 7. Accordingly, explanation thereof is omitted.

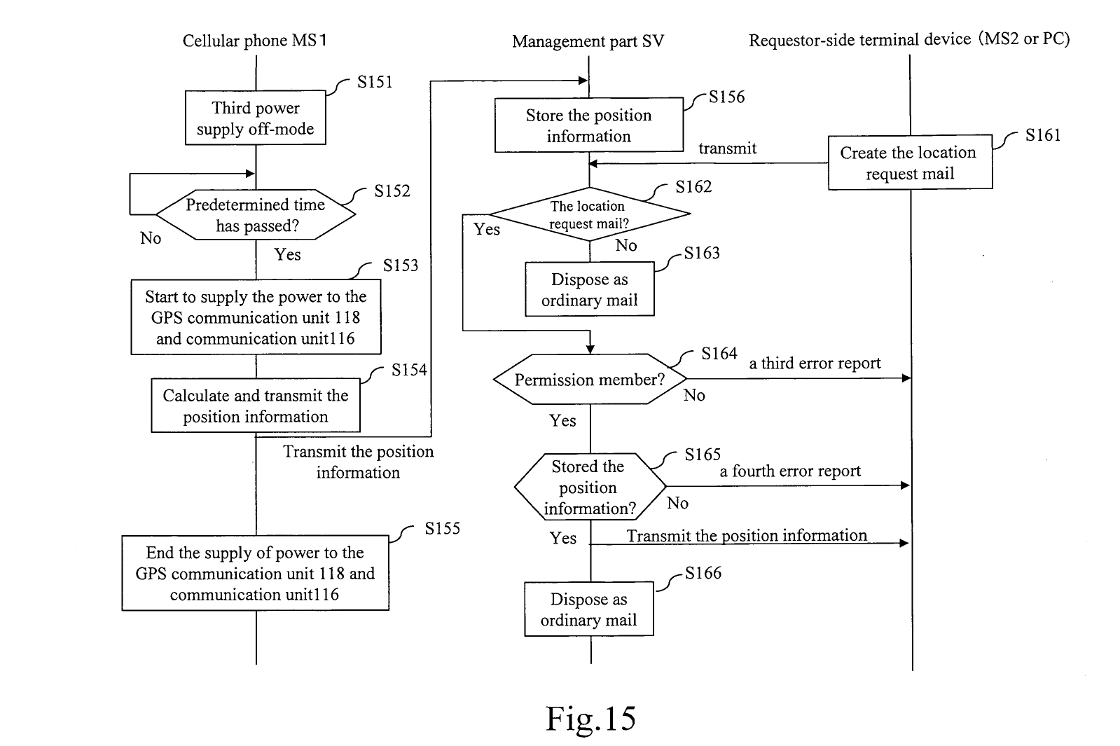

Next, in the third embodiment, a flow of operation when the cellular phone MS1 is in the third power supply off-mode 205 will be described with respect to FIG. 15.

First, operation of the cellular phone MS1 will be explained. After the cellular phone MS1 is set in the third power supply off-mode 205 by the operation shown in FIG. 7 (Step S151), the controller 101 detects whether a predetermined time has passed since the beginning of Step S151 (i.e., since setting the cellular phone MS1 in the third power supply off-mode 205) (Step S152). The controller 101 continues Step S152 until the controller 101 detects that the predetermined time has passed (No of Step S152). In Step S152, if the controller 101 detects that the predetermined time has passed, the controller 101 performs control to initiate power supply to the communication unit 116 and the GPS communication unit 118 (Step S153). Then, the controller 101 performs control so as to acquire the measuring information via the GPS communication unit 118. The GPS communication unit 118 acquires the measuring information from a satellite, and when the controller 101 receives the measuring information, the controller 101 calculates the position information of the cellular phone MS1 based on the measuring information. The controller 101 transmits the calculated position information to the management part SV via the communication unit 116 (Step S154). Then, the controller 101 performs control to stop the supply of power to the communication unit 116 and the GPS communication unit 118 (Step S155).

The management part SV receives the position information, associates the received position information with a measured time (or a calculated time or a received time), and stores the received position information and the measured time in a database (not illustrated) (Step S156).

Next, operation of the requestor-side terminal device MS2 (or PC) and the management part SV will be explained. The requestor-side terminal MS2 (or PC) creates the location request mail (or ordinary mail) and transmits the created mail to the management part SV by the same method as described above with respect to the first embodiment (Step S161). If the management part SV receives the mail, the management part SV detects whether the received mail is the location request mail or the ordinary mail (Step S162). The detection performed in Step S162 is the same as that performed in the first embodiment. If the management part SV detects that the received mail is the location request mail, the management part SV proceeds to Step S164. On the other hand, if the management part SV detects that the received mail is the ordinary mail, the management part SV treats the mail as the ordinary mail (Step S163).

Next, the management section SV detects whether a sender of the received mail is a positioning permission member (i.e., an authorized requester of the position information) (Step S164). The user of the cellular phone MS1 preliminarily transmits and stores a mail address (or addresses) of that are permitted to receive the position information stored in a memory (not shown) of the management part SV, and the detection of the Step S164 is executed by comparing the mail address stored in the memory of the management section SV with the mail address of the sender of the location request mail.

In Step S164, if the management part SV detects that the sender of the received mail is not a positioning permission member (No of Step S164), the management part SV transmits a third error report, which is a notice which indicates that the requester side terminal is not permitted to obtain the position information. If the management part SV detects that the sender of the received mail is a positioning permission member (Yes of Step S164), the management part SV proceeds to Step S165.

Next, in Step S165, the management part SV detects whether position information from the cellular phone MS1 is stored in the database of the management part SV (Step S165). If the management part SV detects that position information from the cellular phone MS1 is not stored in the database of the management part SV, the management part SV transmits a fourth error report, which indicates that the management part SV cannot notify a position result to the requestor-side terminal (No of Step S165). If the management part SV detects position information from the cellular phone MS1 is stored in the database of the management part SV, the management part SV transmits the newest position information to the requestor-side terminal MS2 (or PC) along with the time associated with the position information (Yes of Step S165).

Then, the management part SV transmits the received location request mail to the cellular phone MS1 by the same routine as the ordinary mail (Step S166).

What is claimed is:

1. A communication apparatus for communicating with a radio communication device, comprising:
a display unit;
a controller configured to switch between a first mode, and a second mode in which the display unit is not supplied with power;
a first receiver unit configured to receive a request message from the radio communication device in the second mode;
a second receiver unit configured to receive measuring information that is related to a position of the communication apparatus in response to the request message received by the first receiver unit; and
a transmission unit configured to transmit positioning information that is calculated based on the measuring information.

2. The communication apparatus according to claim 1, wherein
the display unit is supplied with power in the first mode.

3. The communication apparatus according to claim 1, further comprising:
a calculation unit configured to calculate the position information based on the measuring information if the second receiver receives the measuring information.

4. The communication apparatus according to claim 1, wherein
the first receiver unit receives a mail including the request massage, and the second receiver unit receives the measuring information, if the controller detects that a sender of the mail is an authorized sender.

5. The communication apparatus according to claim 4, wherein
the controller prohibits reception of the measuring information if the controller detects that the sender of the mail is not an authorized sender; and
the transmission unit transmits an error report that indicates that the position information cannot be transmitted if the controller detects that the sender of the mail is not an authorized sender.

6. A communication apparatus for communicating with a radio communication device, comprising:
a display unit;
a controller configured to switch between a first mode, and a second mode in which the display unit is not supplied with power;
a first receiver unit configured to receive a demand message from the radio communication device in the second mode; and
a second receiver unit configured to receive information related a position of the communication apparatus in response to the request message being received by the first receiver unit.

7. The communication apparatus according to claim 6, wherein
the display unit is supplied with power in the first mode.

8. The communication apparatus according to claim 6, wherein
the second receiver unit receives measuring information, which comprises time information received from a satellite, and position information related to the position of the communication apparatus is calculated based on the measuring information.

9. The communication apparatus according to claim 8, wherein
the first receiver unit receives a mail including the request massage, and
the second receiver unit receives the measuring information, if controller detects after the mail is received that a sender of the mail is an authorized sender.

10. The communication apparatus according to claim 9, further comprising:
a transmission unit configured to transmit the position information;
wherein the controller prohibits reception of the measuring information, if the controller detects that the sender of the mail is not an authorized sender; and
wherein the transmission unit transmits an error report that indicates that the position information cannot be transmitted if the controller detects that the sender of the mail is not an authorized sender.

11. The communication apparatus according to claim 6, wherein
in the second mode the display unit and the second receiver unit are not supplied with power and the first receiver unit is supplied with power, and
the controller performs control to initiate power supply to the second receiver unit, if the first receiver unit receives the request massage in the second mode.

12. The communication apparatus according to claim 10, wherein
in the second mode the display unit and the second receiver unit are not supplied with power and the first receiver unit is supplied with power, and
the controller performs control to initiate power supply to the second receiver unit if the first receiver unit receives the request massage in the second mode.

13. The communication apparatus according to claim 12, wherein
the controller performs control to end the supply of power to the second receiver unit after the transmission unit transmits the error report.

14. A communication apparatus for communicating with a communication device via a radio network, comprising:
a display unit;
a controller configured to switch between a first mode, and a second mode in which the display unit is not supplied power;
a receiver unit to which power supply is initiated when a predetermined time has passed from a time when the controller was switched into the second mode, and which is configured to receive measuring information that is related a position of the communication apparatus after being supplied power; and
a transmission unit to which power supply is initiated when a predetermined time has passed from the time when the controller was switched into the second mode, and which is configured to transmit position information that is calculated based on the measuring information.

15. The communication apparatus according to claim 14, wherein
the display unit is supplied with power in the first mode.

16. The communication apparatus according to claim 14, wherein
the controller performs control to end the supply of power to the transmission unit after the transmission unit transmits the position information in the second mode.

17. The communication apparatus according to claim 14, wherein
the controller performs control to end the supply of power to the receiver unit after the receiver unit receives the measuring information in the second mode.
